(19) United States
(12) Patent Application Publication
(10) Pub. No.: US 2025/0256456 A1
(43) Pub. Date: Aug. 14, 2025

(54) SYSTEMS AND METHODS FOR TUNABLE MAGNETIC FIELD STRENGTH STEREOLITHOGRAPHY PRINTING FOR VOXELATED HIERARCHICAL STRUCTURES

(71) Applicant: Lawrence Livermore National Security, LLC, Livermore, CA (US)

(72) Inventors: Rodrigo TELLES-ARRIAGA, San Francisco, CA (US); Drew Shrader Melchert, Livermore, CA (US); Caitlyn Christian Krikorian, Livermore, CA (US)

(73) Assignee: Lawrence Livermore National Security, LLC, Livermore, CA (US)

(21) Appl. No.: 19/005,336

(22) Filed: Dec. 30, 2024

Related U.S. Application Data
(60) Provisional application No. 63/551,160, filed on Feb. 8, 2024.

(51) Int. Cl. B29C 64/255; B29C 64/30; B33Y 30/00

(52) U.S. Cl. CPC B29C 64/255; B29C 64/30; B33Y 30/00

(57) ABSTRACT

The present disclosure relates to a projection stereolithography apparatus. The apparatus makes use of a light projector for projecting a two dimensional image into a resin vat containing a quantity of photoresponsive resin. A holder structure is provided for supporting a plurality of magnets. The holder structure supports the plurality of magnets such that the plurality of magnets are spaced at least partially around the resin vat. The plurality of magnets generate a magnetic field for controllably aligning molecules in the resin while forming a three dimensional part in a layer-by-layer process using the two dimensional image projected by the light projector.

### CROSS-REFERENCE TO RELATED APPLICATIONS

This application claims the benefit of U.S. Provisional Application No. 63/551,160 filed on Feb. 8, 2024. The disclosure of the above application is incorporated herein by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to projection stereolithography systems additive manufacturing systems and methods, and more particularly to systems and methods employing high strength magnetic fields for controllably aligning molecules in a photoresponsive resin in a voxel-by-voxel manner during the creation of a 3D part.

### BACKGROUND

The statements in this section merely provide background information related to the present disclosure and may not constitute prior art.

The ability to magnetically manufacture complex structures with programmable anisotropic material alignment in 3D space remains a challenge. Previous efforts (e.g., see R. M. Erb, R. Libanori, N. Rothfuchs, A. R. Studart, Composites Reinforced in Three Dimensions by Using Low Magnetic Fields. Science 335, 199-204 (2012) showed that 3D alignment of particles (e.g., nanorods and discs) could be achieved at low magnetic field strengths (˜10 mT). However, this required the anisotropic particles to have a major axis length of ˜10- 100 μm to avoid thermally-or gravity-dominated alignment. This limitation significantly limited the types of materials that can be used in an additive manufacturing printing system.

Previously developed systems (see, e.g., Erb, Randall, and Joshua J. Martin. “Additive manufacturing of discontinuous fiber composites using magnetic fields.” U.S. Pat. No. 10,703,052. (2020) that have been used to orientate particles have also involved the use of solenoids to generate the magnetic field. This approach, however, while enabling the orientation of particles, is still not able to orientate molecules. Orientating molecules requires significantly stronger magnetic fields to be generated to orientate molecules.

Tabrizi et al. (M. Tabrizi, T. H. Ware, M. R. Shankar, Voxelated Molecular Patterning in Three-Dimensional Freeforms. ACS Appl. Mater. Interfaces 11, 28236-28245 (2019)) demonstrated alignment of diamagnetic liquid crystal elastomers using a field strength of 300 mT, but was limited to alignment in the XY-plane. Other magnetic field-assisted 3D printing examples of orienting anisotropic particles include multimaterial direct ink writing for printing composite materials (see, e.g., D. Kokkinis, M. Schaffner, A. R. Studart, Multimaterial magnetically assisted 3D printing of composite materials. Nat Commun 6, 8643 (2015)), and stereolithography-based methods for printing thermal metamaterials (see e.g., L. Ren, et al., Thermal Metamaterials with Site-Specific Thermal Properties Fabricated by 3D Magnetic Printing. Advanced Materials Technologies 4, 1900296 (2019); and voxelated structures (see, e.g., J. J. Martin, B. E. Fiore, R. M. Erb, Designing bioinspired composite reinforcement architectures via 3D magnetic printing. Nat Commun 6, 8641 (2015); L. Ren, et al., 3D magnetic printing of bio-inspired composites with tunable mechanical properties. J Mater Sci 53, 14274-14286 (2018)).

The assignee of the present disclosure is a leader in the field of additive manufacturing systems. One particular U.S. patent, jointly owned by the assignee of the present disclosure and the President and Fellows of Harvard College, is U.S. Pat. No. 11,745,420 B1 to Telles-Arriaga et al., issued Sep. 5, 2023, for “Stereolithography Additive Manufacturing of Magnetically Aligned Liquid Crystal Elastomers”. This patent involves the application of magnetic fields in different predefined alignment directions for aligning liquid crystal oligomers in different desired directions, in situ, during manufacture of the 3D part. The teachings of this patent are hereby incorporated by reference into the present disclosure.

To overcome all of the above-described limitations, a platform is needed which is capable of generating, on-the-fly, tunable magnetic field strengths, and which also provides tunable magnetic field strengths having higher uniformity over large areas. Such a system would provide the voxel-by-voxel material alignment capability missing in the previously developed systems and methods discussed above.

### SUMMARY

This section provides a general summary of the disclosure, and is not a comprehensive disclosure of its full scope or all of its features.

In one aspect the present disclosure relates to a projection stereolithography apparatus. The apparatus includes a light projector for projecting a two dimensional image into a resin vat containing a quantity of photoresponsive resin, a plurality of magnets, and a holder structure for supporting the plurality of magnets. The plurality of magnets are spaced at least partially around the resin vat. The plurality of magnets generate a magnetic field for controllably aligning molecules in the resin while forming a three dimensional part in a layer-by-layer process using the two dimensional image projected by the light projector.

In another aspect the present disclosure relates to a method for implementing a projection sterolithography process. The method may include projecting a beam of light which forms a two dimensional image into a resin vat containing a quantity of photoresponsive resin. The method may further include using a plurality of magnets held in precise angular orientations around at least a portion of a perimeter of the resin vat, by a holder structure, to generate a magnetic field extending through the resin vat, and controlling the magnetic field such that the magnetic field is greater than 100 mT. This controllably aligns molecules in the resin while forming a three dimensional part in a layer-by-layer process using the two dimensional image.

In still another aspect the present disclosure relates to a projection stereolithography apparatus. The apparatus may include a light projector for projecting a two dimensional image into a resin vat containing a quantity of photoresponsive resin, and a donut-shaped magnet fixedly thereon. The holder has a central cutout sufficiently large to receive the resin vat therein. The donut-shaped magnet generates a magnetic field for controllably aligning molecules in the resin while forming a three dimensional part in a layer-by-layer process using the two dimensional image projected by the light projector.urther areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a schematic diagram of a first cylindrical Halbach permanent magnet (k=2) array holder apparatus accordance with the present disclosure for generating a highly uniform, uniaxial magnetic field in the X/Y plane;

FIG. 2 is a schematic diagram of a second cylindrical Halbach permanent magnet (k=3) array holder apparatus in accordance with the present disclosure for generating a highly uniform, uniaxial magnetic field in the Z plane;

FIG. 3 is a plan view of a Halbach array with square shaped slots for correspondingly shaped permanent magnets, wherein the permanent magnets are supported by an array holder, and where the array holder is affixed to a 5-axis stage for X/Y/Z axis translation, pitch and yaw motion to create uniaxial magnetic fields in any arbitrary direction;

FIG. 4 is a block diagram of one example of system in accordance with the present disclosure which incorporates a Halbach cylinder holder six permanent magnets, and where the array holder structure has been omitted to more clearly illustrate the configuration of the permanent magnets; and

FIG. 5 is a high block diagram of another embodiment of the present disclosure which makes use of a plurality of electromagnets which can be independently controlled (i.e., energized) with currents of varying magnitudes using an electromagnet signal generation subsystem.

### DETAILED DESCRIPTION

Example embodiments will now be described more fully with reference to the accompanying drawings.

The Voxel-by-voxel material alignment in manufactured parts is crucial for locally controlling their mechanical, thermal, electrical, or magnetic properties in different directions. When applied to stimuli responsive materials such as liquid crystal elastomers, a macroscopic 3D-to-3D shape change can be produced. However, the ability to magnetically manufacture complex structures with programmable anisotropic material alignment in 3D space has been a challenge. Furthermore, previously developed methods for magnetic alignment are limited to the X/Y-plane or require paramagnetic particles or surface modification of particles with paramagnetic materials. However, many materials of interest, such as polymers or liquid crystals, are diamagnetic and require high magnetic field strengths >100 mT. To address these limitations, the present disclosure introduces new systems and processing methods capable of generating on-the-fly, high intensity, uniaxial magnetic field strengths, in a controlled fashion along any one or more of the X/Y and Z planes. The present disclosure enables manufacturing complex lattice and other structures in a layer-by-layer fashion using a well known projection stereolithography system, and provides heretofore unachievable 3D voxel-by-voxel alignment and control while carrying out a printing operation.

Referring to FIG. 1, a schematic diagram of a first Halbach array apparatus 10 is shown in accordance with the present disclosure. In this example a plurality of eight permanent magnets (“PMs”) 12a-12h are fixedly arranged in a holder structure 14. In this example the PMs 12a-12h are each square shaped. In some embodiments the PMs may arc-shaped, and in some embodiments a single cylindrical PM may be used. In some embodiments round-shaped or any other suitable shaped magnets may be used. In some embodiments the magnets are of identical construction (i.e., identical shape and overall dimensions), and in some embodiments the PMs 12a-12h differ in one or more of shape, dimensions and/or magnetic field generating capability. Accordingly, the present disclosure is not limited to PMs of any specific shape, dimensions or magnetic field strength capabilities.

In one embodiment the holder structure 14 is formed as a disc-like structure, and manufactured from any non-magnetic and non-electrically conductive material. The holder structure 14 may include cutouts or recesses (e.g., clamp-like arms) sized to the PMs 12a-12h within which the PMs 12a-12h may be fixedly secured. Optionally, other structure such as separate band-like elements (i.e., non-magnetic) may be used which are secured to the holder structure 14 and which extend over the PMs 12a-12h to clamp them in place. In some embodiments the PMs 12a-12h may be fixedly secured to the holder structure 14 by adhesives, a set screw, etc. Any suitable mounting elements/structure may be used to hold the PMs 12a-12h to the holder structure 14, provided the chosen mounting elements/structure does not modify or interfere with the magnetic field generated by its associated PM 12a-12h.

It will also be appreciated that in some embodiments the holder structure 14 may be constructed as two or more independent, vertically stacked structures for holding one or more PMs in a vertically stacked orientation. In some embodiments the stacked structures may be parallel to one another, and in some embodiments that may be arranged non-parallel to one another. Still further, in some embodiments the holder structure 14 may be formed from two or more concentric or non-concentrically arranged rings, in a common X/Y plane, or in two vertically offset X/Y planes. The configurations of the holder structure 14 may enable easier correction for any uniformity issues experienced in the magnetic field that is created by the PMs, and/or a greater range of control over the precise direction of the created magnetic field. Still further, the holder structure 14 may be constructed with a combination of both vertically stacked and multiple concentrically arranged rings. Still further, the holder structure 14 may have the PMs 12a-12h arranged to produce a desired, non-uniform magnetic field. This would allow for gradient alignments during printing.

The PMs 12a-12h each are oriented such that their magnetic poles (represented by arrows within each dashed box) create a high strength, uniaxial magnetic field. This uniaxial magnetic field direction is indicated by arrow 10a in FIG. 1 and is in the X/Y plane. This occurs because the magnetic poles of the PMs 12a/12e and 12e are oriented such the magnetic fields align and are pointed in the exact same direction (i.e., in this example toward the zero degree mark or along the +Y axis), while PMs 12b/12h, 12d/12f have their X axis magnetic field strength components cancel out, leaving only the +Y component; and PMs 12c/12g have their magnetic fields aligned along the Y axis as well.

Referring to FIG. 2, a second Halbach array apparatus 20 is shown in accordance with the present disclosure. In this example the PMs 12a-12h are fixedly arranged on the holder structure 14 with their magnetic poles orientated such that they collectively produce a magnetic field aligned along the Z axis, and pointed in the +Z direction (i.e., coming out of the paper in FIG. 2), as indicated by arrows 20a.

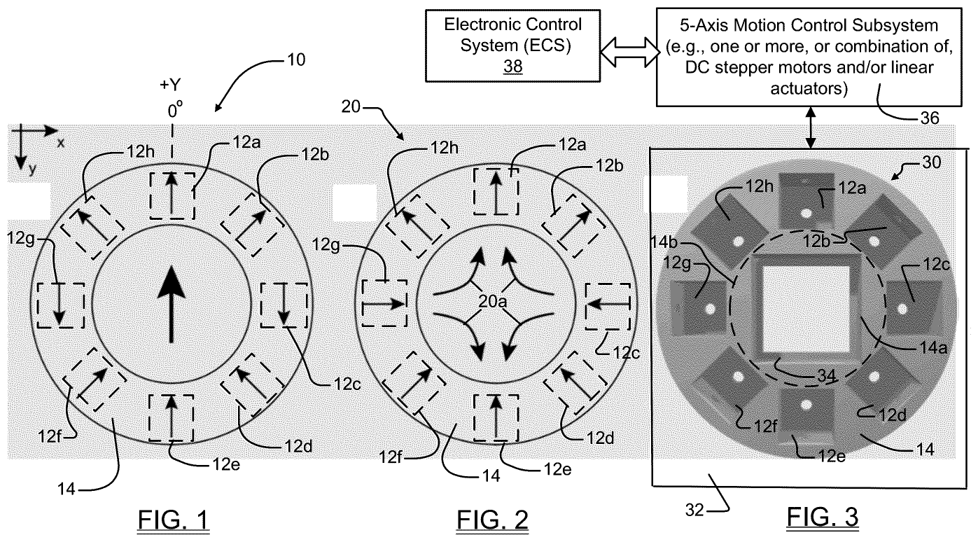

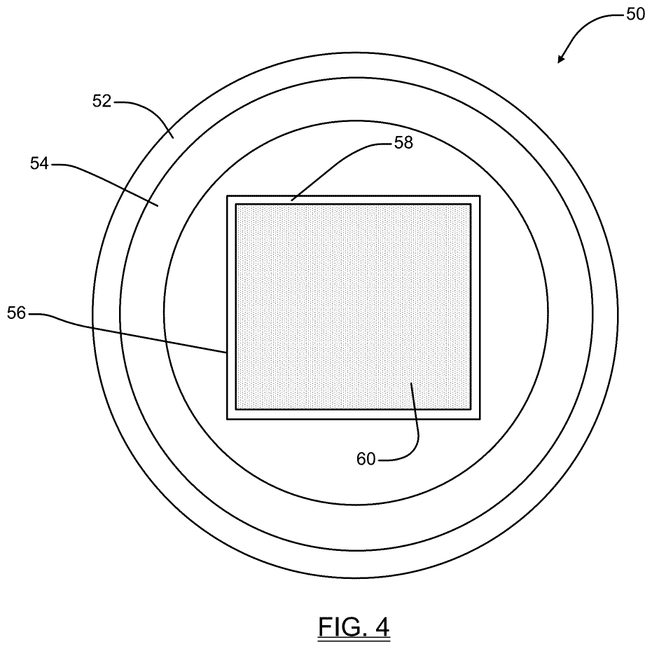

FIG. 3 shows a third Halbach array apparatus 30 in accordance with the present disclosure. In this embodiment the holder structure 14 of the Halbach array apparatus 30 is affixed to a 5-axis movable stage 32. The holder structure 14 includes a cutout 14a within which is disposed a resin vat 34. In some embodiments a circular cutout 14b may be included. The resin vat 34 is supported in a stationary orientation by a suitable support or stage (not shown) and holds a quantity of photoresponsive resin. The 5-axis movable stage 32 likewise includes a central opening for accommodating the resin vat 34 and may be controlled by a 5-axis motion control system 36. Five-axis motion control system 36 may be controlled with control/command signals provided by an external electronic control system 38. Alternatively the 5-axis motion control subsystem 36 may include an internal electronic control system, computer or suitable processor (not shown), to generate the needed control/command signals. It will also be appreciated that the holder structures 14 illustrated in FIGS. 1 and 2 could just as readily be coupled to a 5-axis motion control subsystem, as described for the holder structure of FIG. 3.

By affixing the Halbach array 30 to the 5-axis movable stage 32, selected movement of the Halbach array within each of the X, Y and Z planes, or any combination thereof, can be achieved. This enables the magnetic field direction generated by the PMs 12-12h to be aligned along any one of five axes as needed to achieve any one of translation in the X, Y or Z planes, or control over pitch or yaw, of the apparatus 30 to be achieved. As a result, high strength, uniaxial magnetic fields can be generated to induce material alignment in any arbitrary direction.

With brief reference to FIG. 4, another embodiment of a Halbach array 50 is shown. The Halbach array 50 in this example includes a holder structure 52 (e.g., disc-like member) having a circular (e.g., donut-shaped) PM 54 mounted thereon. Again, the circular PM 54 may be secured to the holder structure 54 via any suitable means, such as, without limitation, mounting within a circular recess of the holder structure 52, via adhesives or via external non-metallic straps that clamp the circular PM 54 securely to the holder structure. A cutout 56 may be formed in the holder structure 52 within which a resin vat 58 is positioned. The resin vat 58 may hold a quantity of a photopolymer 60. In some embodiments the Halbach array 50 may be used with a 5 axis movable stage as described for the Halbach array 30 of FIG. 3.

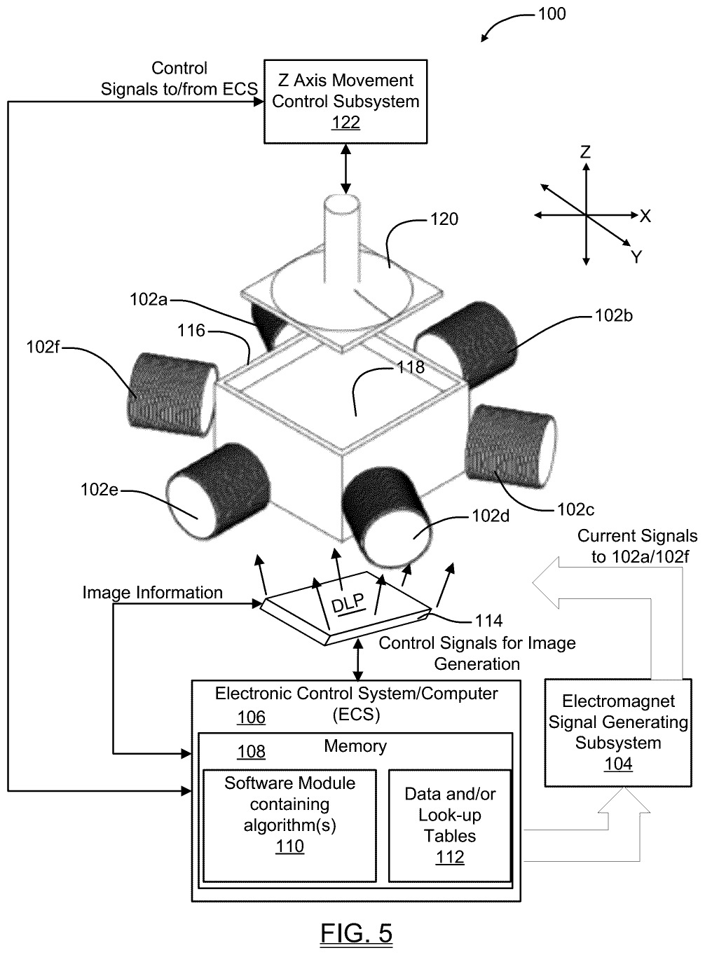

During printing with any of the Halbach arrays 10, 20, 30 and 50, the sample stage (not shown) on which the 3D part is being formed in a layer-by-layer process is lowered within the photopolymer resin vat 34 to the desired layer height. The Halbach array 10, 20, 30 or 50 is then positioned around the resin vat in a selected 3D orientation, the targeted alignment state is “locked-in” locally by photo-crosslinking one or more selected areas of the layer being formed with a suitable mask. And the Halbach arrays 10, 20, 30 and 50 described herein are not limited to use with any specific form of mask. Referring now to FIG. 5, a system 100 in accordance with another embodiment of the present disclosure is shown. The system 100 in this example incorporates a plurality of electromagnets 102a-102f which can be independently controlled (i.e., energized) with currents of varying magnitudes using an electromagnet signal generation subsystem 104. The electromagnet signal generation subsystem 104 may in turn be controlled by an electronic control subsystem (“ECS”) 106. The ECS 106 may include a memory 108 with one or more software modules 110 containing needed algorithms for controlling a build process, and one or more data or look-up tables 112 for storing needed data (or historical part information) helpful in carrying out a 3D part build. And while six electromagnets 102a-102f are shown, it will be appreciated that the system 100 is not limited to use with any specific number of electromagnets. It is anticipated that 4-6 electromagnets will be preferred in most implementations. It will also be understood that potentially the complexity of the 3D part being made, as well as other variables (e.g., number of windings of the electromagnets, amperage, current carrying capacity, spacing between solenoids and electromagnets, etc.), will have a bearing.

Referring further to FIG. 5, in some embodiments a digital light projector (DLP) 114 is used to generate the 2D images that are projected into a quantity of resin 118 contained within a resin vat 116. A build stage 120 on which the 3D part is to be formed is included and movable along the Z axis by a Z axis motion control subsystem 122. The Z axis motion control subsystem 122 may itself be controlled by the ECS 106 or by a separate controller, or possibly by an internal controller.

The system 100, with the use of electromagnets 102a-102f and coupled with projection stereolithography (FIG. 2), enables generating both static and dynamically changing magnetic fields, as well as the ability to controllably vary magnetic field strengths “on-the-fly” (i.e., in situ) as each layer of a 3D part is being crosslinked. The magnetic field strength will be determined by the input current to each electromagnet 102a-102f (i.e., from the electromagnet signal generating subsystem 104 or a different subsystem), as well as other factors such as the number of windings of each electromagnet, a length of the solenoid associated with each electromagnet, and possibly still other factors as well.

In some embodiments the electromagnets 102a-102h are formed by placing a ferromagnetic material, typically soft iron or mild steel, but not necessarily limited to these specific materials, within a tightly wound solenoid to amplify the magnetic field strength while reducing the amount of current needed. In some embodiments it is possible that the electromagnets 102a-102f may be shaped other than as shown in FIG. 5, and therefore the present disclosure is not limited to the use of electromagnetics of any specific shape or configuration. In some embodiments the electromagnets 102a-102f may have an arcuate configuration or non-linear shape.

Configuring the electromagnets 102a-102f in a cylindrical Hallbach array as shown in the FIG. 5 configuration provides the ability to generate relatively large (>100 mT) and highly uniform magnetic field strengths within the resin vat 116. The use of DC or AC current will determine the resultant magnetic field direction. For example, when supplying AC current to electromagnets placed 120 degrees apart or with a current that is 120 degrees out of phase, a rotating field can be generated. Therefore, constructive and destructive interference can be exploited to generate more complex magnetic fields, leading to even greater and more complex control over the orientation of molecules in the photoresponsive resin 118 being polymerized.

The use of additive manufacturing such as projection stereolithography printing, coupled with the magnetic alignment described herein, makes the system 100 especially well suited for producing hierarchical lattice structures that are capable of novel mechanical properties and complex 3D-to-3D shape morphing. By using permanent magnets in a Halbach array configuration or electromagnets, a uniform uniaxial magnetic field is generated which is capable of creating large field strengths (at least >100 mT) required for aligning diamagnetic materials (e.g., water, carbon (diamond or graphite forms), silver and most polymers/molecules). The systems and methods disclosed herein enable effective control for aligning magnetically responsive materials from 0D to 3D, including nanoparticles, carbon nanotubes, alumina platelets, and metallo-organic frameworks.

The systems and methods described herein enable custom designed Halbach arrays to be constructed which may incorporate permanent magnets or electromagnets, which in both cases enable a uniform magnetic field to be created in any user-specified direction. The use of electromagnets included with the system 100 provides a facile route towards on-the-fly tunable magnetic field strength to be achieved in real time during polymerization of each layer of a 3D part. Coupling with projection stereolithography, locally aligned regions can be “locked into” place by curing during 3D printing. A significant feature of the present disclosure is the ability generate relatively large magnetic field strengths (>100 mT) in arbitrary directions, enabling alignment on smaller scales than previously possible.

Ultimately, the systems and methods of the present disclosure are expected to enable 3D architected structures with anisotropic material alignment and subsequent 3D-to-3D shape change programmability. As such, the present disclosure represents a new approach to encoding anisotropic material properties and 3D-to-3D architected shape change using a projection stereolithography process.

It will also be appreciated that the various embodiments discussed herein may potentially be employed in various other additive manufacturing processes including, but not limited to, Direct Ink Write (“DIW”), volumetric additive manufacturing (“VAM”), Fused Deposition Modeling, 2-photon polymerization, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A projection stereolithography apparatus including:
a light projector for projecting a two dimensional image into a resin vat containing a quantity of photoresponsive resin;
a plurality of magnets;
a holder structure for supporting the plurality of magnets, wherein the plurality of magnets are spaced at least partially around the resin vat; and
the plurality of magnets generating a magnetic field for controllably aligning molecules in the resin while forming a three dimensional part in a layer-by-layer process using the two dimensional image projected by the light projector.

2. The system of claim 1, wherein at least one of the plurality of magnets comprises a permanent magnet.

3. The system of claim 1, wherein at least one of the plurality of magnets comprises an electromagnet.

4. The system of claim 1, wherein:
ones of the plurality of magnets are arranged to be supported by the holder structure to fully circumscribe the vat of resin; and
the plurality of magnets configured to produce a magnetic field in a selected direction within at least one of an X/Y plane or a Z plane.

5. The system of claim 4, wherein the plurality of magnets comprise a plurality of permanent magnets.

6. The system of claim 4, wherein the plurality of magnets comprise a plurality of electromagnets.

7. The system of claim 6, further comprising an electromagnetic signal generating subsystem for generating a plurality of current signals for controllably energizing select ones of the plurality of electromagnets.

8. The system of claim 1, wherein the holder is configured to support the plurality of magnets equidistantly spaced apart from one another fully circumferentially around the plurality of magnets.

9. The system of claim 1, further comprising a motion control subsystem for translating the holder structure in at least one of:
an X/Y plane; or
a Z plane perpendicular to the X/Y plane.

10. The system of claim 9, wherein the motion control subsystem comprises a 5-axis motion control subsystem.

11. The system of claim 1, wherein the plurality of magnets have a common dimension and shape.

12. The system of claim 1, wherein the holder forms a disc-like shape and is constructed of a non-magnetic and non-electrically conductive material.

13. The system of claim 1, wherein the magnetic field generated by the plurality of magnets is greater than 100 mT.

14. A method for implementing a projection stereolithography process, including:
projecting a beam of light which forms a two dimensional image into a resin vat containing a quantity of photoresponsive resin;
using a plurality of magnets held in precise angular orientations around at least a portion of a perimeter of the resin vat, by a holder structure, to generate a magnetic field extending through the resin vat; and
controlling the magnetic field such that the magnetic field is greater than 100 mT to controllably align molecules in the resin while forming a three dimensional part in a layer-by-layer process using the two dimensional image.

15. The method of claim 14, wherein projecting a beam of light comprises projecting a beam of light from a digital light projector.

16. The method of claim 14, wherein using a plurality of magnets comprises using a plurality of permanent magnets having magnetic poles thereof selectively arranged to create a magnetic line of force in a selected direction through the resin vat.

17. The method of claim 14, wherein using a plurality of magnets comprises using a plurality of electromagnets that are controllably energized to create a magnetic line of force in a selected direction through the resin vat.

18. The method of claim 14, wherein using a plurality of magnets held in precise angular orientations around at least a portion of a perimeter of the resin vat, by a holder structure comprises using a holder structure having a circular donut shape dimensioned to be positioned over the resin vat such that the resin vat is disposed in a central circular opening of the holder.

19. The method of claim 18, wherein using a holder structure having a circular donut shape comprises using a holder having a circular donut shape, and which is constructed of a non-magnetic material and non-electrically conductive material.

20. A projection stereolithography apparatus comprising:
a light projector for projecting a two dimensional image into a resin vat containing a quantity of photoresponsive resin;
a donut-shaped magnet;
a holder structure for supporting the donut-shaped magnet fixedly thereon, wherein the holder has a central cutout sufficiently large to receive the resin vat therein; and
the donut-shaped magnet generating a magnetic field for controllably aligning molecules in the resin while forming a three dimensional part in a layer-by-layer process using the two dimensional image projected by the light projector.
